(19) United States
(12) Patent Application Publication
(10) Pub. No.: US 2006/0101348 A1
(43) Pub. Date: May 11, 2006

(54) Method and device for composing sms message

(75) Inventor: Galileo J. A. Destura, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/540,183

(22) PCT Filed: Dec. 11, 2003
(86) PCT No.: PCT/IB03/05964

§ 371 Date: Jun. 20, 2005

(30) Foreign Application Priority Data
Dec. 20, 2002 (US) 60435234

(51) Int. Cl. G06F 17/00; G06F 3/00

(52) U.S. Cl. 715/773

(57) ABSTRACT

A user of a mobile phone (20) composes a message on a display screen (21) of the mobile phone (20) by a selective application of various load levels upon various areas of the display screen (21) that correspond to keys of a virtual keypad (23). An application of a load upon a localized area of one of the keys will display one of a plurality of characters associated with the respective key. A sensed and measured level of the applied load determines which of the characters is displayed on the display screen (21).

The present invention generally relates is wireless communication devices. The present invention specifically relates to a Short Messaging Service (“SMS”) of a mobile phone.

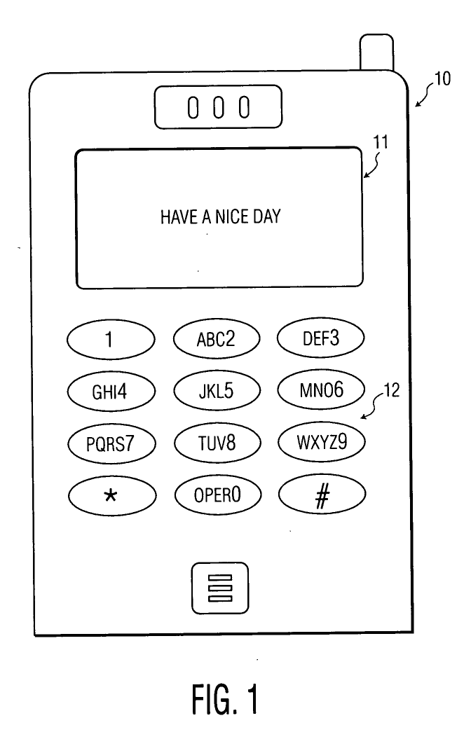

FIG. 1 illustrates a mobile phone 10 having a standard keypad 11 and a display screen 12. The following TABLE 1 lists the number of button presses associated with a display of each alphabetic character, numeric character and symbolic character of keypad 11:

TABLE 1

| 1 PRESS | 2 PRESSES | 3 PRESSES | 4 PRESSES | 5 PRESSES |
|---|---|---|---|---|
| 1 | | | | |
| A | B | C | 2 | |
| D | E | F | 3 | |
| G | H | I | 4 | |
| J | K | L | 5 | |
| M | N | 0 | 6 | |
| P | Q | R | S | 7 |
| T | U | V | 8 | |
| W | X | Y | Z | 9 |
| * | | | | |
| 0 | | | | |
| # | | | | |

Consequently, sending a message of “HAVE A NICE DAY” as illustrated would require a user of mobile phone 10 to perform a total of twenty-seven (27) key presses [H(2P), A(1P), V(3P), E(2P), SPACE, A(1P), SPACE, N(2P), I(3P), C(3P), E(2P), SPACE, D(1P), A(1P), and Y(3P)]. Clearly, sending longer and/or more elaborate messages can be time consuming and burdensome for a user of mobile phone 10.

One form of the present invention is a wireless communication device (e.g., a mobile phone, a personal data assistant, etc.) for composing a message. The device comprises a display screen and a virtual keypad having a plurality of keys displayed on the display screen. The virtual keypad includes a first key operable to display a first character associated with the first key within the message as displayed on the display screen in response to an application of a first load level upon a localized area of the display screen corresponding to the first key. The first key is further operable to display a second character associated with the first key within the message as displayed on the display screen in response to an application of a second load level upon the localized area of the display screen corresponding to the first key.

A second form of the present invention is a method of operating a wireless communication device in composing a message. The wireless communication device includes a display screen and a virtual keypad having a plurality of keys displayed on the display screen. First, an application of a load upon a localized area of the display screen corresponding to a first key of the virtual keypad is sensed and measured. Second, a first character associated with the first key is displayed within the message in response to the load equating a first load level. Third, a second character associated with the first key is displayed within the message in response to the load equating a second load level.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates a front view of a standard mobile phone;

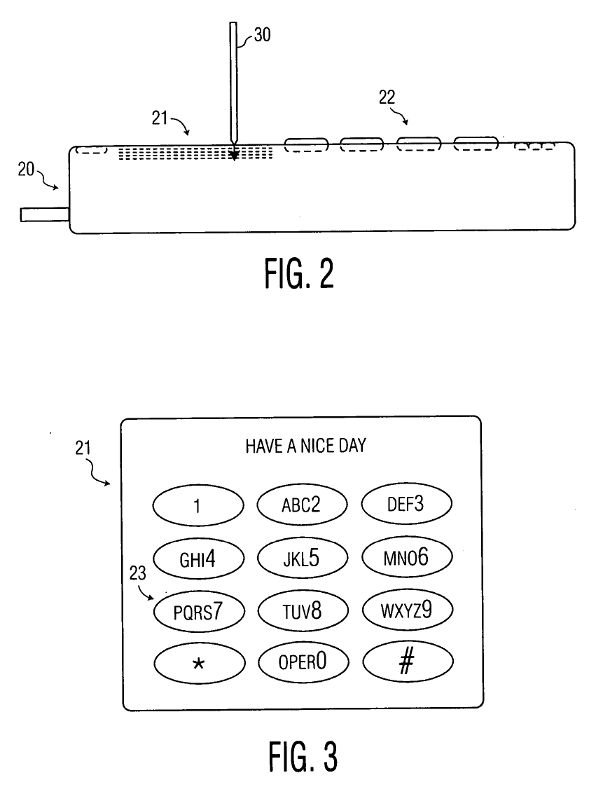

FIG. 2 illustrates a side view of one embodiment of a mobile phone in accordance with the present invention;

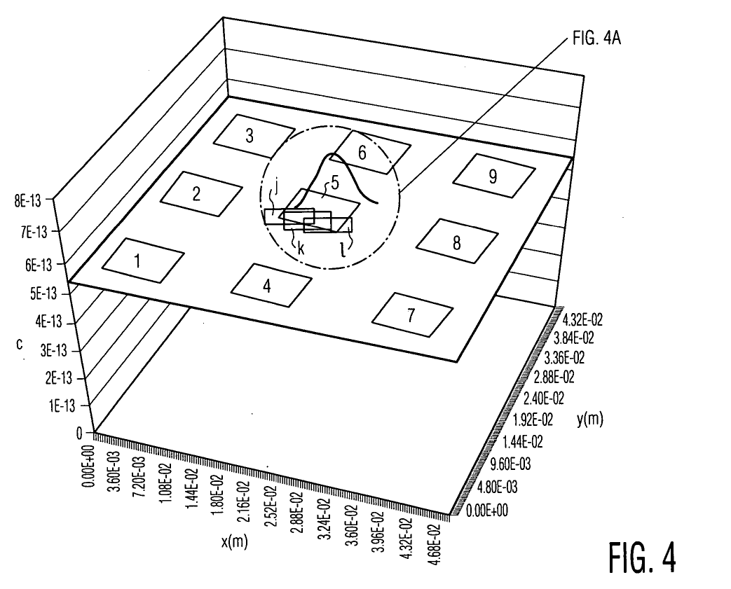

FIG. 3 illustrates a front view of one embodiment of a display screen and a virtual keypad of the mobile phone illustrated in FIG. 2;

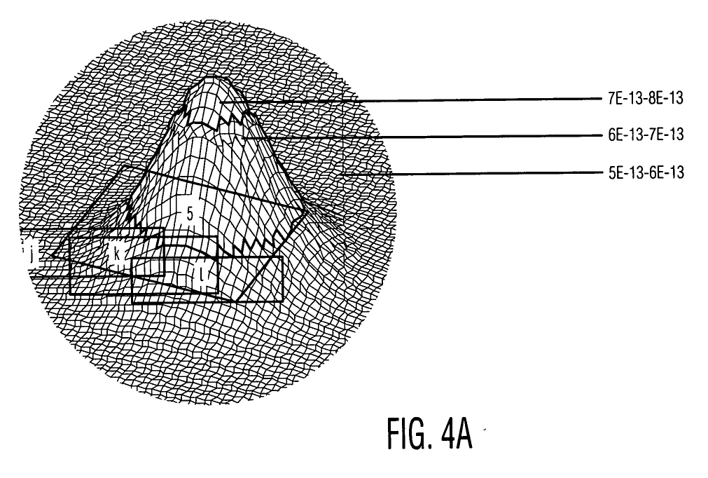

FIG. 4 illustrates one embodiment of a capacitance profile of the display screen illustrated in FIG. 3; and

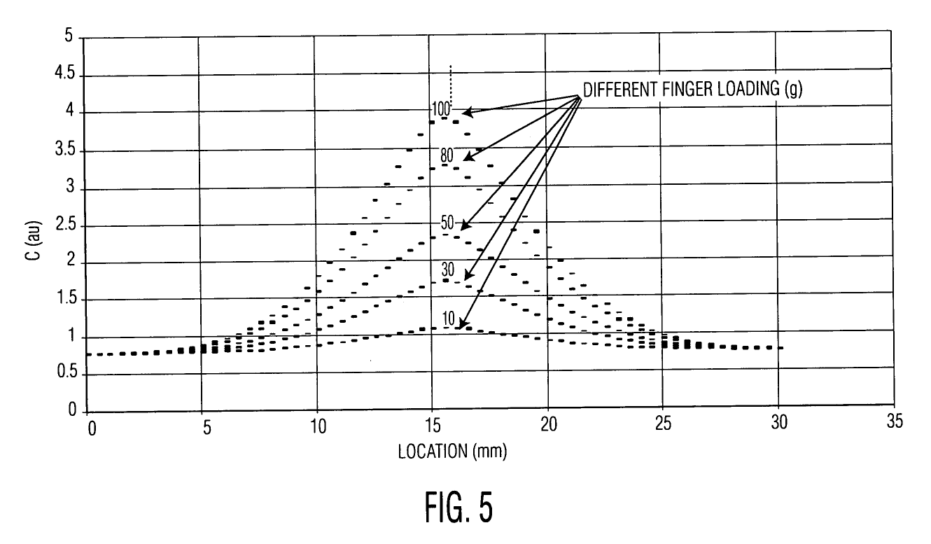

FIG. 5 illustrates one embodiment of a cross sectional capacitance of a key of the virtual keypad illustrated in FIG. 3.

FIG. 2 illustrates a mobile phone 20 having a touch sensitive display screen 21 and a standard keypad 22. The touch sensitive display screen 21 is responsive to an application of a load upon an area of display screen 21, such as, for example, the downward load being applied to display screen 21 via a stylus 30 as illustrated in FIG. 2. The downward load may be applied by other instruments as would occur to those having ordinary skill in the art, such as, for example, a finger of a user of mobile phone 20. In one embodiment, the touch sensitive display screen 21 is fabricated and operated in accordance European Patent Application Serial No. 02076461.9, entitled “Touch Sensitive Display Device” and filed Apr. 15, 2002, which is hereby incorporated by reference.

FIG. 3 illustrates a display of a virtual keypad 23 on the touch sensitive display screen 21. Each illustrated key of the virtual keypad 23 has one or more associated characters (e.g., alphabetic, numeric or symbolic). Each key of virtual keypad 23 is further assigned to a localized area of the touch sensitive display screen 21, such as, for example, the area of display screen 21 directly above a key. Accordingly, when a user of mobile phone 20 desires to compose a message, the user sequentially applies various load(s) in the localized area(s) corresponding to the key(s) required to the compose the message. For any given key, a sensed and measured level of the load determines which character associated with the key will be displayed within the message on display screen 21.

FIG. 4 illustrates a profile of a capacitive-based embodiment of the touch sensitive display screen 21. From FIG. 4, coordinates of a localized area of display screen 21 for each key can be ascertained. A capacitance of each key equals a base level in the absence of an application of a load upon a corresponding localized area, such as, for example, 0.5 pF as illustrated in FIG. 4. A capacitance of each key increases upon an application of a load upon a corresponding localized area, such as, for example, the profile of capacitance of key “jkl5” as illustrated in FIG. 4. The degree to which the capacitance increases is indicative of the amount of load being applied to the corresponding localized area. Each character associated with a key is further associated with a different load level to thereby ascertain when the user of mobile phone 20 desires to include a specific character within the message on display screen 21.

FIG. 5 illustrates a cross-sectional view of five (5) load levels representative of an application of five (5) different load levels upon a localized area of key of the virtual keypad 23 (FIG. 3). The five (5) load levels include a 10% increase in capacitance of a key, a 30% increase in capacitance of a key, a 50% increase in capacitance of a key, a 80% increase in capacitance of a key, and a 100% increase in capacitance of a key. The following TABLE 2 exemplarity lists an association of each load level with one or more characters:

TABLE 2

| 10% | 30% | 50% | 80% | 100% |
|---|---|---|---|---|
| 1 | | | | |
| A | B | C | 2 | |
| D | E | F | 3 | |
| G | H | I | 4 | |
| J | K | L | 5 | |
| M | N | O | 6 | |
| P | Q | R | S | 7 |
| T | U | V | 8 | |
| W | X | Y | Z | 9 |
| * | | | | |
| 0 | | | | |
| # | | | | |

Consequently, sending a message of “HAVE A NICE DAY” as illustrated would require a user of mobile phone 10 to perform a total of fifteen (15) key presses [H(1P), A(1P), V(1P), E(1P), SPACE, A(1P), SPACE, N(1P), I(1P), C(1P), E(1P), SPACE, D(1P), A(1P), and Y(1P)], for a total decrease of twelve (12) presses. Clearly, sending longer and/or more elaborate messages will be less time consuming and burdensome for a user of mobile phone 20.

In one embodiment, each load level of TABLE 1 represents a minimum load level within a range encompassing the load level. Thus, a measurement of a load equates the 10% load level when a load measurement LM is within a range of 10%≦LM<30%, a measurement of a load equates the 30% load level when a load measurement LM is within a range of 30%≦LM<50%, and so on and so on.

In a second embodiment, each load level of TABLE 1 represents a maximum load level within a range encompassing the load level. Thus, a measurement of a load equates the 10% load level when a load measurement LM is within a range of 0%<LM≦10%, a measurement of a load equates the 30% load level when a load measurement LM is within a range of 10%<LM≦30%, and so on and so on.

In a third embodiment, each load level of TABLE 1 represents load level within a range encompassing the load level. Thus, a measurement of a load equates the 10% load level when a load measurement LM is within a range of 0%<LM≦20%, a measurement of a load equates the 30% load level when a load measurement LM is within a range of 20%<LM≦40%, and so on and so on.

The number of load levels associated with a key is without limit. The following TABLE 3 exemplarily lists another association of load levels with one or more characters:

TABLE 3

| 10% | 20% | 30% | 40% | 50% | 60% | 80% | 90% | 100% |
|---|---|---|---|---|---|---|---|---|
| 1 | | | | | | | | |
| A | a | B | b | C | c | 2 | | |
| D | d | E | e | F | f | 3 | | |
| G | g | H | h | I | i | 4 | | |
| J | j | K | k | L | l | 5 | | |
| M | m | N | n | O | o | 6 | | |
| P | p | Q | q | R | r | S | s | 7 |
| T | t | U | u | V | v | 8 | | |
| W | w | X | x | Y | y | Z | z | 9 |
| * | | | | | | | | |
| 0 | | | | | | | | |
| # | | | | | | | | |

It is important to note that FIGS. 2-5 illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A wireless communication device (20) for composing a message, said device (20) comprising:
a display screen (21); and
a virtual keypad (23) having a plurality of keys displayed on said display screen (21),
wherein said virtual keypad (23) includes a first key operable to display a first character associated with said first key within the message as displayed on said display screen (21) in response to an application of a first load level upon a localized area of said display screen (21) corresponding to said first key, and
wherein said first key is further operable to display a second character associated with said first key within the message as displayed on said display screen (21) in response to an application of a second load level upon the localized area of said display screen (21) corresponding to said first key.

2. The wireless communication device (20) of claim 1, wherein said first key is further operable to display a third character associated with said first key within the message as displayed on said display screen (21) in response to an application of a third load level upon the localized area of said display screen (21) corresponding to said first key.

3. The wireless communication device (20) of claim 2, wherein said first key is further operable to display a fourth character associated with said first key within the message as displayed on said display screen (21) in response to an application of a fourth load level upon the localized area of said display screen (21) corresponding to said first key.

4. The wireless communication device (20) of claim 5, wherein said first key is further operable to display a fifth character associated with said first key within the message as displayed on said display screen (21) in response to an application of a fifth load level upon the localized area of said display screen (21) corresponding to said first key.

5. In a wireless communication device (20) including a display screen (21) and a virtual keypad (23) having a plurality of keys displayed on the display screen (21), a method of composing a message, said method comprising:
sensing and measuring an application of a load upon a localized area of the display screen (21) corresponding to a first key of the virtual keypad (23);
displaying a first character associated with the first key within the message as displayed on the display screen (21) in response to a measurement of the load equating a first load level; and
displaying a second character associated with the first key within the message as displayed on the display screen (21) in response to a measurement of the load equating a second load level.

6. The method of claim 5, further comprising:
displaying a third character associated with the first key within the message as displayed on the display screen (21) in response to a measurement of the load equating a third load level.

7. The method of claim 6, further comprising:
displaying a fourth character associated with the first key within the message as displayed on the display screen (21) in response to a measurement of the load equating a fourth load level.

8. The method of claim 7, further comprising:
displaying a fifth character associated with the first key within the message as displayed on the display screen (21) in response to a measurement of the load equating a fifth load level.
